(19) United States
(12) Patent Application Publication
(10) Pub. No.: US 2026/0267459 A1
(43) Pub. Date: Sep. 10, 2026

(54) INFORMATION PROCESSING METHOD, INFORMATION PROCESSING DEVICE, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventor: Kazuko NISHIMURA, Kyoto (JP)

(73) Assignee: PANASONIC INTELLECTUAL PROPERTY MANAGEMENT CO., LTD., Osaka (JP)

(21) Appl. No.: 19/656,609

(22) Filed: Apr. 23, 2026

Related U.S. Application Data
(63) Continuation of application No. PCT/JP2024/037772, filed on Oct. 23, 2024.
(60) Provisional application No. 63/546,998, filed on Nov. 2, 2023.

(30) Foreign Application Priority Data
Jun. 19, 2024 (JP) 2024-098838

(51) Int. Cl. G06F 3/04815; G06V 20/70

(52) U.S. Cl. CPC G06F 3/04815; G06V 20/70

(57) ABSTRACT

An information processing method includes displaying, a first image that is obtained by capturing a prescribed space on a first date and time, displaying, on the display, a second image that is obtained by capturing the prescribed space on a second date and time that is different from the first date and time, and upon detection of a selection of a selection image capture point that is different from an image capture point on the first date and time or the second date and time while the first image and the second image are being displayed, switching display of the first image to display of a third image that is obtained at the selection image capture point, and also switching the display of the second image to the display of a fourth image that is captured at a corresponding image capture point that corresponds to the selection image capture point.

### FIELD OF INVENTION

The present disclosure relates to a technique of displaying a selected image.

### BACKGROUND ART

Patent Literature 1 discloses an image information generation apparatus that, in a case where information requesting comparison between a first omnidirectional image and a second omnidirectional image is input, selects a second omnidirectional image whose image capture position coordinates are closest to image capture position coordinates of the first omnidirectional image from all second omnidirectional images captured at a second image capture opportunity, and generates and outputs a composite image in which the second omnidirectional image and the first omnidirectional image are arranged in a comparable manner.

However, Patent Literature 1 does not disclose processing of directly shifting from a state of comparison display in which the first omnidirectional image and the second omnidirectional image are compared to each other to a state of comparison display in which the first omnidirectional image and the second omnidirectional image having different image capture points are compared to each other. Therefore, in order to implement this processing in Patent Literature 1, it is necessary to return to selection of a corresponding image in the first omnidirectional image once and then to display comparison image, and there is a problem that processing steps increase and a burden on a computer increases.

Patent Literature 1: JP 2022-012444 A

### SUMMARY OF THE INVENTION

The present disclosure has been made to solve such a problem, and an object of the present disclosure is to provide a technique capable of displaying a plurality of images captured at another image capture point in a state where comparison display of the plurality of images is maintained without increasing processing steps.

An information processing method according to an aspect of the present disclosure is an information processing method in a computer, the method including displaying, on a display of an information terminal, a first image that is obtained by capturing a prescribed space on a first date and time, displaying, on the display, a second image that is obtained by capturing the prescribed space on a second date and time that is different from the first date and time, and upon detection of a selection of a selection image capture point that is different from an image capture point on the first date and time or the second date and time while the first image and the second image are being displayed, switching display of the first image to display of a third image that is obtained at the selection image capture point, and switching the display of the second image to display of a fourth image that is captured at a corresponding image capture point that corresponds to the selection image capture point.

### BRIEF DESCRIPTION OF THE DRAWINGS

FIG. 1A is an overall configuration diagram of an information processing system according to a first embodiment.

FIG. 1B is an overall configuration diagram of an information processing system according to a modification of the first embodiment.

FIG. 2 is a diagram illustrating an example of a design drawing screen on which an image capture point icon is mapped.

FIG. 3A is a diagram illustrating an example of a display screen displayed on a display in a case where the image capture point icon is selected.

FIG. 3B is a diagram illustrating an example of the display screen displayed on the display in a case where the image capture point icon is selected in a modification of the first embodiment.

FIG. 4 is a diagram illustrating a comparison screen.

FIG. 5 is a diagram illustrating a comparison screen to be displayed next to FIG. 4.

FIG. 6 is a diagram illustrating a comparison screen in a case where a BIM image is displayed as an nth comparison image.

FIG. 7 is a flowchart illustrating processing of the information processing system in the first embodiment.

FIG. 8 is a diagram illustrating a comparison screen on which annotation information is displayed.

FIG. 9 is a diagram illustrating a comparison screen to be displayed after the comparison screen shown in FIG. 8.

FIG. 10 is a flowchart illustrating processing of an information processing system in a second embodiment.

FIG. 11 is a flowchart illustrating processing of an information processing system in a third embodiment.

FIG. 12 is a flowchart illustrating processing of an information processing system in a fourth embodiment.

FIG. 13 is a flowchart illustrating processing of the information processing system in a fifth embodiment.

### DETAILED DESCRIPTION

### Knowledge Underlying Present Disclosure

There has been developed a user interface that displays a plurality of image capture point icons indicating image capture points at which a construction site or the like is actually captured on a two-dimensional design drawing of the construction site or the like, and, displays an image captured at an image capture point indicated by one image capture point icon when the one image capture point icon is selected. As a result, the administrator of the construction site can know the situation of the construction site without visiting the construction site.

In such a user interface, there is also considered a function of comparing and displaying a first image captured at an image capture point indicated by a selection image capture point icon and a second image captured at an image capture point that is a second image captured at a date and time different from a date and time of the first image and is close to the image capture point of the first image (for example, Patent Document 1). As a result, a supervisor can easily check a progress status of construction.

However, in the related art, in a case where a walk-through display of the first image is performed while the first image and the second image are being compared and displayed, the walk-through display of the second image is not performed in conjunction with the walk-through display. The walk-through display refers to a display mode in which a plurality of images captured at a plurality of image capture points are switched and displayed one after another in response to a user’s operation. As a result, the user can obtain a feeling as if the user is actually walking in the image capturing site, that is, a visual sense from a first-person viewpoint.

In Patent Document 1, in a case where the first image and the second image compared and displayed are switched to the first image and the second image captured at a different image capture point, there are required processing of receiving an instruction to leave the comparison display and displaying a selection screen of the image capture point, processing of receiving selection of the image capture point from the selection screen and displaying the first image, processing of receiving information requesting comparison and displaying the second image, and the like. This increases processing steps and burden on a computer.

Therefore, the present inventors have found that such a problem can be solved if the walk-through display of the second image is performed in conjunction with the walk-through display of the first image in a case where the walk-through display of the first image is performed while the first image and the second image are being compared and displayed, and have arrived at the present disclosure.

(1) An information processing method according to an aspect of the present disclosure is an information processing method in a computer, the method including displaying, on a display of an information terminal, a first image that is obtained by capturing a prescribed space on a first date and time, displaying, on the display, a second image that is obtained by capturing the prescribed space on a second date and time that is different from the first date and time, and upon detection of a selection of a selection image capture point that is different from an image capture point on the first date and time or the second date and time while the first image and the second image are being displayed, switching display of the first image to display of a third image that is obtained at the selection image capture point, and switching the display of the second image to display of a fourth image that is captured at a corresponding image capture point that corresponds to the selection image capture point.

In this configuration, upon detection of the selection of the selection image capture point while the first image and the second image are being displayed, the first image is switched to the third image captured at the selection image capture point, and the second image is switched to the fourth image captured at the corresponding image capture point that corresponds to the selection image capture point. It is therefore possible to perform walk-through display of two images having different image capture dates and times. As a result, it is possible to display a plurality of images captured at another image capture point while maintaining the comparison display of the plurality of images without increasing processing steps.

(2) In the information processing method according to (1), each of the first image, the second image, the third image, and the fourth image may be configured by an omnidirectional image.

In this case, the status of the prescribed space can be confirmed in more detail.

(3) In the information processing method according to (1), one of an image group including the first image and the third image or an image group including the second image and the fourth image may be configured by an omnidirectional image, and another one of the image groups may be configured by a three-dimensional simulation image of the prescribed space or a two-dimensional bird’s eye image of the prescribed space.

In this case, it is possible to perform walk-through display in which the omnidirectional image of the prescribed space is compared with the three-dimensional simulation image or the two-dimensional bird’s-eye image of the prescribed space. Therefore, a user can easily confirm a progress status of construction in the prescribed space. The three-dimensional simulation image includes a three-dimensional CAD image and a BIM image.

(4) The information processing method according to any of (1) to (3) may further include displaying the first image and the second image on the display such that image capture directions coincide with each other and displaying the third image and the fourth image on the display such that image capture directions of the third image and the fourth image coincide with each other.

In this case, since it is possible to perform walk-through display of two images having different image capture dates and times while the viewpoints coincide with each other, the two images can be easily compared.

(5) The information processing method according to any of (1) to (4) may further include displaying the first image and the second image on the display such that angles of view coincide with each other and displaying the third image and the fourth image on the display such that angles of view of the third image and the fourth image coincide with each other.

In this case, since it is possible to perform walk-through display of two images having different image capture dates and times while the angles of view coincide with each other, the two images can be easily compared.

(6) The information processing method according to any of (1) to (5) may further include, in a case where one of the first image or the second image includes annotation information, determining whether an annotation object corresponding to the annotation information is included in another one of the first image or the second image and at least one of the third image or the fourth image, and displaying the annotation information in an image determined to include the annotation object among the another image, the third image, and the fourth image.

In this case, if the annotation information is included in one of the first image or the second image, when an annotation object corresponding to the annotation information exists in the other one of the first image or the second image and at least one of the third image or the fourth image, the annotation information can be displayed in the image in which the annotation object exists. Therefore, it is easy to confirm the annotation information.

(7) In the information processing method according to any of (1) to (6), the corresponding image capture point may be an image capture point at which a distance to the selection image capture point is shortest among image capture points at which the distance to the selection image capture point is a designated distance or less.

In this case, since two images having close image capture points are compared and displayed, it is easy to confirm a status change in a prescribed space.

(8) In the information processing method according to any of (1) to (7), the corresponding image capture point may be an image capture point whose image capture date and time are within a designated time from the selection image capture point.

In this case, since the two images whose image capture date and time are within the designated time are compared and displayed, it is easy to confirm the status change in the prescribed space within the designated time.

(9) In the information processing method according to any of (1) to (8), the prescribed space may include a plurality of subspaces, and the method may further include determining whether an image capture point of the first image and an image capture point of the second image are located in a same subspace, and displaying the second image upon determination that the image capture points are located in the same subspace, and determining whether an image capture point of the third image and an image capture point of the fourth image are located in a same subspace, and displaying the fourth image upon determination that the image capture points are located in the same subspace. Here, the subspace means a space surrounded by columns or walls. For example, the subspace is a space in the same room as the prescribed space or in the same corridor and refers to a space in which visibility is not obstructed by a pillar or the like during construction.

In this case, it is easy to compare two images captured in the same subspace. In a case where the subspace is not defined, there is a possibility that an image of the prescribed space and an image of a subspace different from the prescribed space are compared and displayed instead of the image of the prescribed space and the image of the space in the same room or the same corridor. In this case, the field of view is blocked by the pillar or the wall, the desired site cannot be compared, and as a result, there is a possibility that the comparison target becomes an error. By defining the subspace, the occurrence of the error is suppressed.

(10) In the information processing method according to any of (1) to (9), the third image may be an image captured on a date and time one date and time before or one date and time after the first date and time, and the fourth image may be an image captured on a date and time one date and time before or one date and time after the second date and time, or may be an image captured at an image capture point close to an image captured on a date and time one date and time before or one date and time after the first date and time, and may be an image captured at an image capture time close to a date and time one date and time before or one date and time after the second date and time.

In this case, the walk-through display of the third image and the fourth image can be performed so as to move on an image capture locus actually followed by the photographer in the prescribed space.

(11) In the information processing method according to any of (1) to (10), the second image may be an image captured at an image capture point corresponding to the image capture point of the first image.

This configuration can prevent the first image and the second image that do not correspond to the image capture point from being displayed.

(12) An information processing device according to another aspect of the present disclosure includes a processor that executes displaying, on a display of an information terminal, of a first image that is obtained by capturing a prescribed space on a first date and time, displaying, on the display, of a second image that is obtained by capturing the prescribed space on a second date and time that is different from the first date and time, and upon detection of a selection of a selection image capture point that is different from an image capture point on the first date and time or the second date and time while the first image and the second image are being displayed, switching of display of the first image to display of a third image that is obtained at the selection image capture point, and switching of the display of the second image to display of a fourth image that is captured at a corresponding image capture point that corresponds to the selection image capture point.

In this case, it is possible to provide an information processing device capable of displaying a plurality of images captured at another image capture point while maintaining the comparison display of the plurality of images without increasing processing steps.

(13) An information processing program according to a still another aspect of the present disclosure causes a computer to display, on a display of an information terminal, a first image that is obtained by capturing a prescribed space on a first date and time, display, on the display, a second image that is obtained by capturing the prescribed space on a second date and time that is different from the first date and time, and upon detection of a selection of a selection image capture point that is different from an image capture point on the first date and time or the second date and time while the first image and the second image are being displayed, switch display of the first image to display of a third image that is obtained at the selection image capture point, and switch the display of the second image to display of a fourth image that is captured at a corresponding image capture point that corresponds to the selection image capture point.

In this case, it is possible to provide an information processing program capable of displaying a plurality of images captured at another image capture point while maintaining the comparison display of the plurality of images without increasing processing steps.

The present disclosure can be also implemented as an information processing system that is operated by such an information processing program. It is needless to say that such a computer program can be distributed via a computer-readable non-transitory recording medium such as a CD-ROM or via a communication network such as the Internet.

Note that each embodiment to be described below illustrates a specific example of the present disclosure. Numerical values, shapes, components, steps, order of steps, and the like of the embodiments below are merely examples, and are not intended to limit the present disclosure. A component not described in an independent claim representing a highest concept among components in the embodiments below is described as an optional component. In all the embodiments, pieces of content can be combined.

### First Embodiment

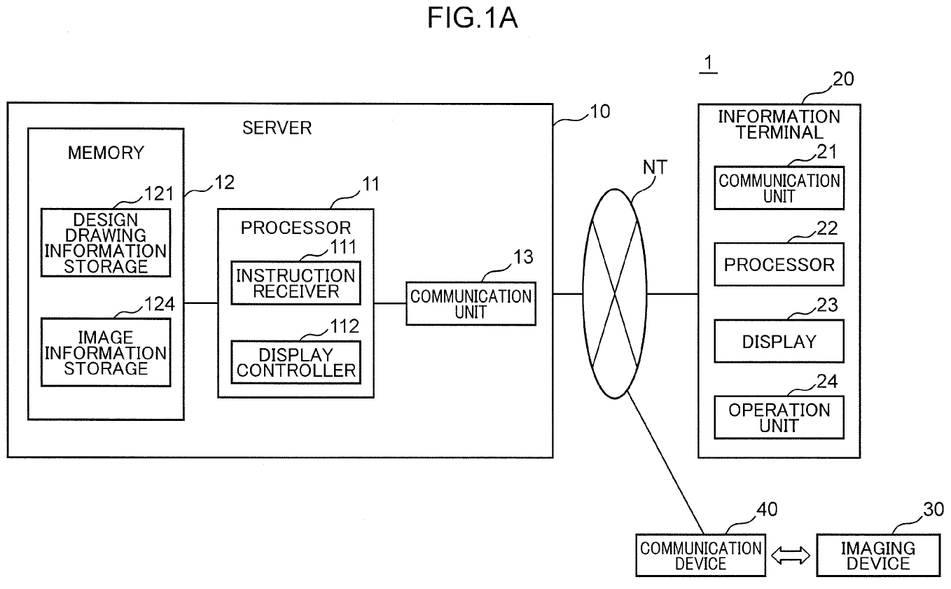

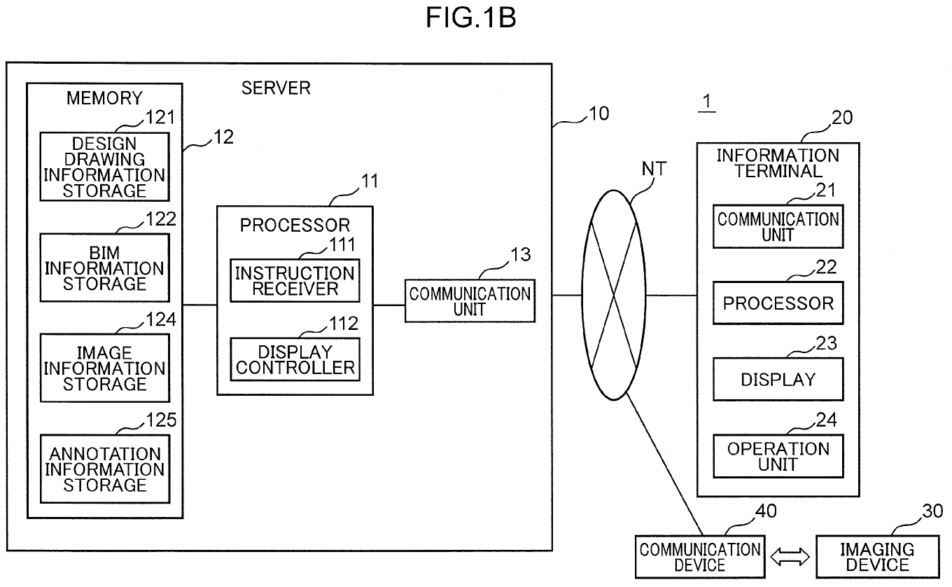

FIG. 1A is an overall configuration diagram of an information processing system 1 according to a first embodiment. The information processing system 1 is a system that enables walk-through display while maintaining comparison display of two images having different image capture dates and times. The information processing system 1 includes a server 10, an information terminal 20, an imaging device 30, and a communication device 40. The server 10 (an example of an information processing device and a computer), the information terminal 20, and the communication device 40 are communicably connected to each other via a network NT. An example of the network is the Internet. The server 10 is, for example, a cloud server configured by one or a plurality of computers. However, this is an example, and the server 10 may be configured by an edge server or may be implemented in the information terminal 20. An aspect in which the server 10 is implemented in the information terminal 20 is an example of an aspect in which the information terminal 20 is configured by an information processing device.

The information terminal 20 is carried by a user. The user is, for example, an administrator of a prescribed space captured by the imaging device 30. The prescribed space is, for example, a building site. However, this is an example, and the prescribed space may be a construction site, a factory, a store, an office, or the like. The information terminal 20 may be configured by, for example, a portable computer such as a smartphone or a tablet computer or may be configured by a stationary computer. The information terminal 20 displays an image on a display under the control of the server 10. Although one information terminal 20 is illustrated in the example of FIG. 1A, a plurality of information terminals may be connected to the server 10 via the network. The information terminal 20 includes a communication unit 21, a processor 22, a display 23, and an operation unit 24.

The communication unit 21 is a communication interface that connects the information terminal 20 to the network NT. The communication unit 21 transmits instruction signals indicating various instructions received from the user by the operation unit 24 to the server 10. The communication unit 21 receives display data for displaying various display screens from the server 10.

The processor 22 is configured by, for example, a central processing unit, and displays the display screen indicated by the display data received by the communication unit 21 on the display 23.

The display 23 is configured by various display devices such as a liquid crystal display and an organic EL display, and displays various display screens under the control of the processor 22.

The operation unit 24 is configured by a keyboard, a touch panel, a mouse, and the like, and receives various instructions input by the user.

The communication device 40 is configured by, for example, a portable information terminal such as a smartphone or a tablet computer, and connects the imaging device 30 to the network NT. The communication device 40 and the imaging device 30 are connected via a proximity wireless communication path such as Bluetooth (registered trademark).

The imaging device 30 is configured by, for example, an omnidirectional camera, and captures an image at a predetermined frame rate. The omnidirectional camera is also referred to as a 360 degree camera and is a camera capable of acquiring an omnidirectional image of 360 degrees. The imaging device 30 is, for example, a portable imaging device carried by a photographer. The photographer is, for example, a worker at a building site or a site supervisor. Note that the imaging device 30 may be configured by a normal camera.

The photographer moves in the building site while capturing the building site with the imaging device 30. When image capturing is completed, the imaging device 30 transmits image capture information including a series of captured images to the server 10 via the communication device 40. A period from when the photographer starts image capturing to when the photographer finishes image capturing is referred to as an image capture period.

The image capture information includes a captured image and meta information. The meta information includes an image capture start point and an image capture end point.

The image capture date and time is acquired by, for example, a clock included in the imaging device 30. Here, since the imaging device 30 captures an image at a predetermined frame rate, the image capture point is defined on a frame period basis. However, in this case, since the data amount becomes enormous, the image capture point may be defined every predetermined time (for example, one second, five seconds, ten seconds, one minute, or the like).

The photographer presses an image capture button of the imaging device 30 by directing an image capture direction of the imaging device 30 to, for example, the north at an image capture start position to start image capturing. When the photographer reaches an image capture end point, the photographer presses the image capture button again to end the image capturing.

The image capture start point and the image capture end point are specified by the photographer inputting an instruction to designate the position on a design drawing screen of the site displayed on the display of the communication device 40. Two-dimensional coordinate axes are defined on the design drawing screen. Therefore, the image capture start position and the image capture end position are defined by two-dimensional coordinate values. The image capture start point and the image capture end point are used by the server 10 to specify the position of each image capture point and the image capture direction of each image. The position of each image capture point can be specified from the image capture start point, the image capture end point, and the image by using visual simultaneous localization and mapping (VSLAM). The position of each image capture point is represented by a two-dimensional coordinate value on the design drawing. The image capture direction of each image is also specified by using initial direction setting and SLAM technique. The image capture direction of each image is represented by, for example, a three-dimensional or two-dimensional polar coordinate vector. Note that the communication device 40 may calculate the position of each image capture point and the image capture direction of each image.

The server 10 includes the processor 11, the memory 12, and a communication unit 13. The processor 11 is configured by, for example, a central processing unit (CPU). The processor 11 includes an instruction receiver 111 and a display controller 112. The instruction receiver 111 and the display controller 112 may be implemented by the processor 11 executing the information processing program or may be configured by a dedicated hardware circuit such as an ASIC.

The instruction receiver 111 acquires an instruction by the user input to the information terminal 20. Specifically, in a case where the communication unit 13 receives the instruction signal indicating the instruction transmitted from the information terminal 20, the instruction receiver 111 detects the input of the instruction by the user. The instruction includes, for example, a comparison instruction, a walk-through instruction, and the like. The comparison instruction is an instruction to compare and display two images captured on the site and having different image capture dates and times. The walk-through instruction is an instruction for walk-through display of the two images compared and displayed.

The display controller 112 displays, on the display 23 of the information terminal 20, a first image obtained by capturing the prescribed space on a first image capture date and time (an example of a first date and time). The display controller 112 displays, on the display 23, a second image obtained by capturing a prescribed space on a second image capture date and time (an example of a second date and time) that is different from the first image capture date and time. The first image capture date and time is one image capture date and time included in a first image capture period. The first image capture period is a period from the image capture start time to the image capture end time in one image capture period. The second image capture date and time is one image capture date and time included in a second image capture period. The second image capture period is an image capture period different from the first image capture period.

The second image is an image captured at an image capture point corresponding to the image capture point of the first image. The corresponding image capture point is, for example, an image capture point having the shortest distance of the image capture points belonging to the second image capture period with respect to the image capture point of the first image.

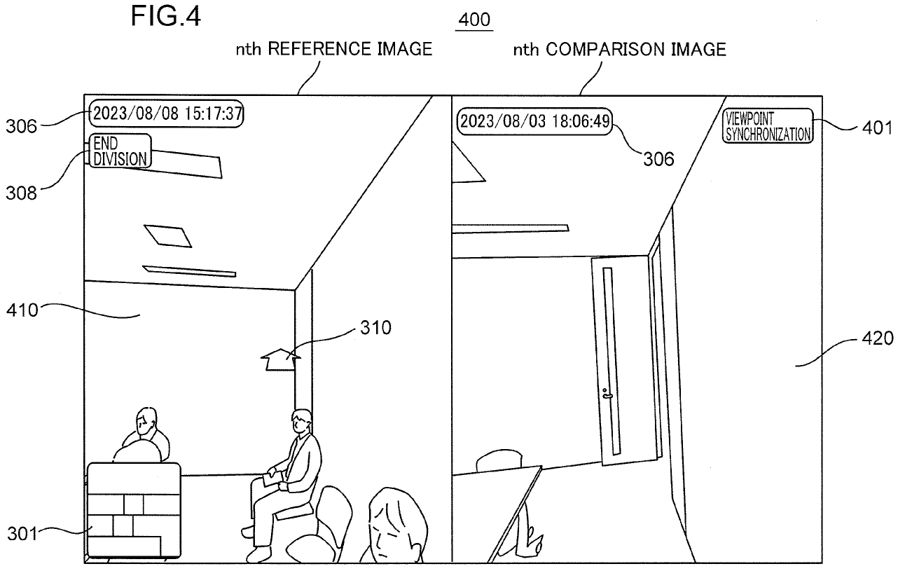

The display controller 112 detects selection of a selection image capture point that is an image capture point different from the image capture point on the first image capture date and time or the second image capture date and time while the first image and the second image are being compared and displayed. This selection is performed, for example, by the user inputting an operation of pressing a walk-through instruction button 310 illustrated in FIG. 4. The comparison display indicates that two images having different image capture points are displayed side by side as illustrated in FIG. 4.

When detecting the selection, the display controller 112 switches the display of the first image to a third image captured at the selection image capture point, and switches the display of the second image to a fourth image captured at the corresponding image capture point which is the image capture point corresponding to the selection image capture point.

The third image is an image captured on an image capture date and time one date and time before or one date and time after the first image capture date and time. The image capture date and time one date and time before the first image capture date and time is an image capture date and time that belongs to the first image capture period and is one date and time earlier than the first image capture date and time. The image capture date and time one date and time after the first image capture date and time is an image capture date and time that belongs to the first image capture period and is one date and time later than the first image capture date and time. The image capture date and time is represented by year, month, day, hour, minute, and second.

The fourth image is an image captured on an image capture date and time one date and time before or one date and time after the second image capture date and time. The image capture date and time one date and time before the second image capture date and time is an image capture date and time that belongs to the second image capture period and is one date and time earlier than the second image capture date and time. The image capture date and time one date and time after the second image capture date and time is an image capture date and time that belongs to the second image capture period and is one date and time later than the second image capture date and time. Alternatively, the fourth image may be an image captured at an image capture point close to an image captured on a date and time one date and time before or one date and time after the first date and time and an image captured at an image capture time close to a date and time one date and time before or one date and time after the second date and time. The fact that the image capture points are close means that the image capture points are located within a predetermined distance. The fact that the image capture time is close means that the image capture date and time is within a predetermined time.

The display controller 112 displays the first image and the second image on the display 23 so that the image capture directions coincide with each other. The display controller 112 displays the third image and the fourth image on the display 23 so that the image capture directions coincide with each other.

Here, the display controller 112 determines a display region of the first image in a rectangular shape centered on the viewpoint of the first image mapped on a spherical surface. The viewpoint is an intersection point between the omnidirectional image mapped on the spherical surface and the image capture direction of the imaging device 30. Therefore, the display controller 112 sets the same viewpoint as the first image in the second image mapped on the spherical surface and determines the display region of the rectangular second image centered on the set viewpoint. As a result, the display controller 112 causes the image capture direction of the second image to coincide with the image capture direction of the second image. Similarly, the display controller 112 sets the same viewpoint as the viewpoint of the third image in the fourth image mapped on the spherical surface and sets a rectangular display region centered on the viewpoint to cause the image capture direction of the fourth image to coincide with the image capture direction of the third image.

The display controller 112 displays the first image and the second image on the display 23 so that the angles of view coincide with each other. The display controller 112 displays the third image and the fourth image on the display 23 so that the angles of view coincide with each other. The angle of view refers to the display region of each of the first image to the fourth image. Causing the angles of view to coincide with each other means matching a vertical width and a horizontal width of the display region of each of the first image to the fourth image. The same applies to the second image to the fourth image.

The user can arbitrarily change the magnification of each of the first image to the fourth image displayed on the display 23. For example, when the magnification of the first image is changed, the display controller 112 changes the display ranges of the first image and the second image according to the changed magnification. In this manner, the display controller 112 also varies the magnification of the second image in conjunction with the variation of the magnification of the first image. The same applies to the third image and the fourth image.

Each of the first image, the second image, the third image, and the fourth image is configured by an omnidirectional image. However, this is an example, and one of an image group including the first image and the third image or an image group including the second image and the fourth image may be configured by an omnidirectional image, and the other one of the image groups may be configured by a three-dimensional simulation image of the prescribed space or a two-dimensional bird’s eye image of the prescribed space. An example of the two-dimensional bird’s-eye image is a design drawing. The three-dimensional simulation image is a three-dimensional CAD image or a building information modeling (BIM) image obtained by rendering three-dimensional CAD information or BIM information. For example, in a case where the prescribed space is a building site, an image obtained by rendering BIM information of a completed building on the basis of an image capture direction of an image to be compared and displayed is adopted as the three-dimensional simulation image.

The memory 12 is configured by a nonvolatile rewritable storage device such as a hard disk drive or a solid-state drive. The memory 12 includes a design drawing information storage 121 and an image information storage 124. The design drawing information storage 121 stores design drawing information. The design drawing information is image information indicating the design drawing of the prescribed space. The design drawing information is associated with a design drawing ID for identifying the design drawing. The design drawing is a diagram illustrating a design of a building site, and may be a plan view, a blueprint, a map, a perspective view, or the like of the building site. The bird’s-eye view can also be referred to as an overhead view and may be an overview or a view from high above.

The image information storage 124 stores image information. The image information is information in which a plurality of images captured at a plurality of image capture points is associated with meta information of each image. The image information is generated every time the image capture information described above is transmitted. The meta information includes an image capture ID, an image capture period ID, an image capture date and time, an image capture direction, an image capture point, and a design drawing ID. The image capture date and time is the image capture date and time of the image. The image capture direction is the image capture direction of the imaging device 30 that has captured the image. The image capture point is configured by a position (two-dimensional coordinate value) indicating the image capture point of the image.

The image capture ID is an identifier of the image capture point. The image capture period ID is an identifier of the image capture period. The design drawing ID is an identifier of the design drawing of the prescribed space corresponding to the image.

The communication unit 13 is a communication interface that connects the server 10 to the network.

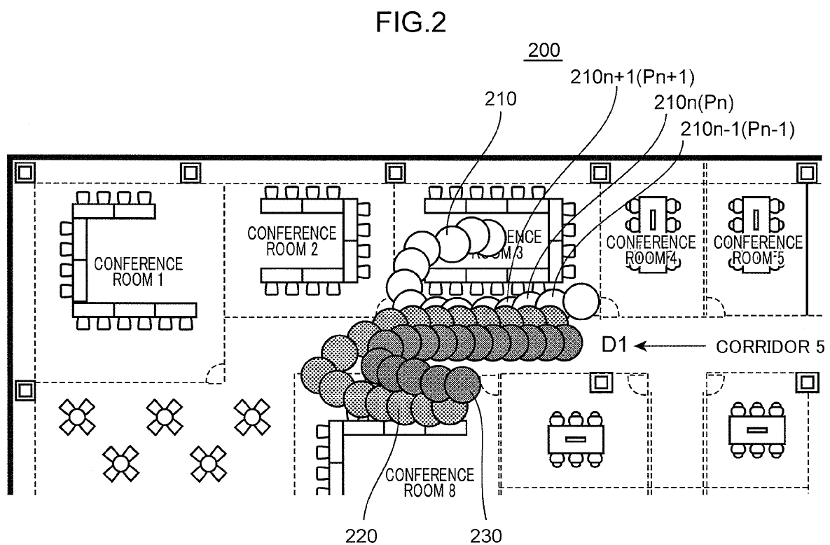

FIG. 2 is a diagram illustrating an example of the design drawing screen 200 on which the image capture point icon 210 is mapped. The design drawing screen 200 displays a design drawing of the prescribed space. On the design drawing screen 200, the image capture point icon 210 is displayed in a superimposed manner.

The image capture point icon 210 is an icon indicating an image capture point and is associated with an image. In this example, the image capture point icon 210 is configured by a circular image. The plurality of image capture point icons 210 displayed here corresponds to a plurality of image capture points belonging to one image capture period. A route following from the image capture point icon 210 at a distal end to the image capture point icon 210 at a terminal end indicates a locus followed by the photographer in this image capture period. A movement direction D1 indicates a direction followed by the photographer.

Loci 220 and 230 indicate the loci of the photographer in an image capture period different from the image capture period to which the image capture point icon 210 belongs. For example, in a case where the image capture period to which the image capture point icon 210 belongs is the latest image capture period, the loci 220 and 230 indicate the loci of the past image capture periods. Here, the loci 220 and 230 are displayed for convenience of description, but the loci 220 and 230 are not required to be displayed. The movement direction D1 is not required to be displayed.

In a case where the instruction receiver 111 receives an instruction to select one of the pluralities of image capture point icons 210 (for example, an image capture point icon 210n), the display controller 112 displays an image Gn corresponding to the image capture point icon 210n on the display 23. An image capture point icon 210n+1 indicates an image capture point Pn+1 one image capture date and time after the image Gn, and an image capture point icon 210n-1 indicates an image capture point Pn-1 one image capture date and time before the image Gn.

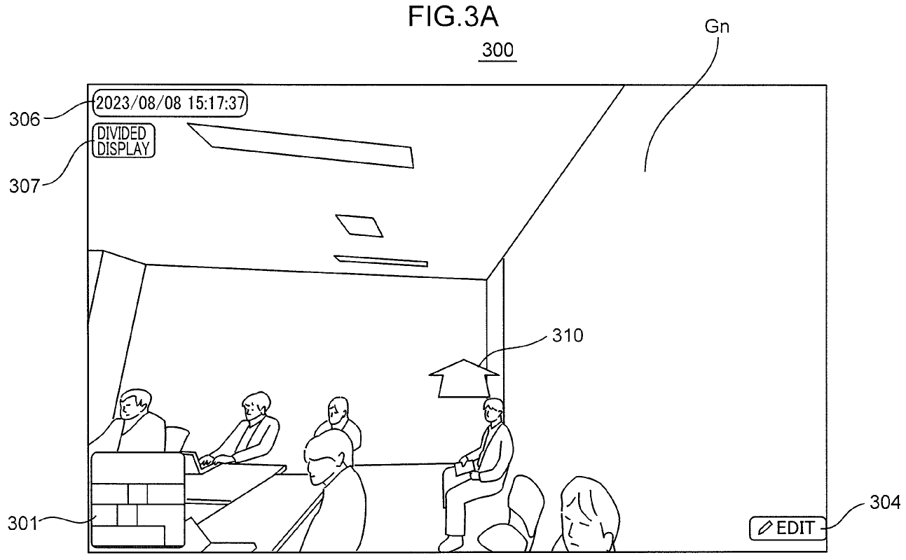

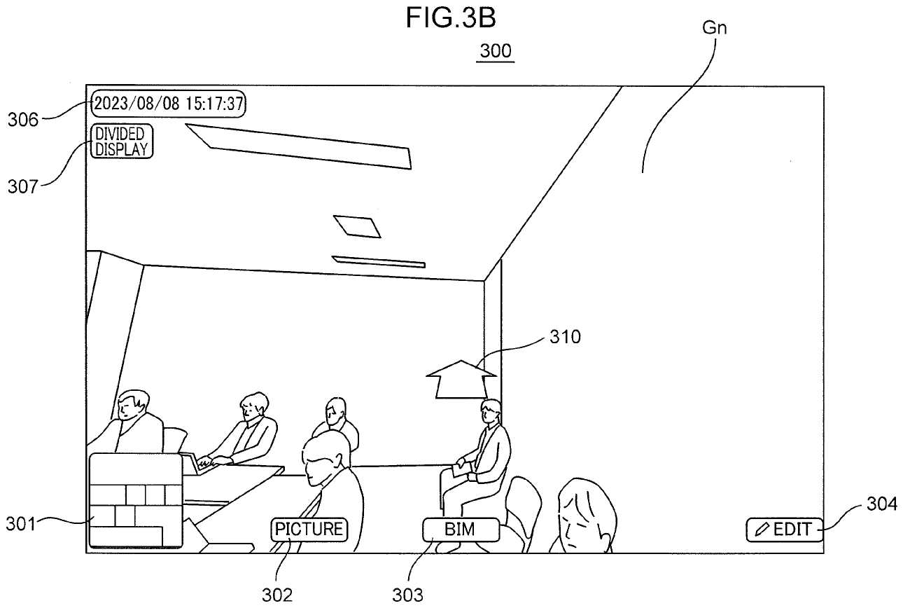

FIG. 3A is a diagram illustrating an example of the display screen 300 displayed on the display 23 in a case where the image capture point icon 210n is selected. The display screen 300 displays the image Gn captured at an image capture point Pn corresponding to the image capture point icon 210n. The display screen 300 includes a design drawing display field 301, an edit button 304, a date field 306, a comparison instruction button 307, and a walk-through instruction button 310.

The design drawing display field 301 reduces and displays the design drawing screen 200 illustrated in FIG. 2. The date field 306 displays the image capture date and time of the image Gn. The comparison instruction button 307 is a button for comparing and displaying the image Gn and the image captured at the image capture point corresponding to the image capture point Pn.

The walk-through instruction button 310 is a button for switching the image Gn to an image Gn+1 one image capture date and time later. In the example of FIG. 2, the image captured at the image capture point Pn+1 corresponds to the next image Gn+1. Note that the user can also switch the image Gn to an image Gn-1 captured at the image capture point Pn-1. In this case, the display controller 112 is only required to display the walk-through instruction button 310 and the walk-through instruction button 310 in a direction opposite to the walk-through instruction button 310 on the display 23 in response to an instruction of the user, and is only required to display the image Gn-1 in a case where an instruction to select the walk-through instruction button 310 in the direction opposite to the walk-through instruction button is input.

In this manner, by inputting the instruction to select the walk-through instruction button 310, the user can sequentially switch and display the images Gn captured during the image capture period on the display 23. As a result, the user can perform the walk-through display of the image Gn.

FIG. 4 is a diagram illustrating a comparison screen 400. The comparison screen 400 is displayed on the display 23 in a case where the instruction receiver 111 receives a selection instruction of the comparison instruction button 307.

The comparison screen 400 includes a first region 410 and a second region 420 which are divided into two regions of left and right. The first region 410 displays an nth reference image, and the second region 420 displays an nth comparison screen.

The nth reference image is an image Gn displayed on the display screen 300 in a case where an instruction to select the walk-through instruction button 310 is input. The nth reference image is an image captured at the nth image capture point Pn of the plurality of image capture points belonging to the first image capture period. The first image described above corresponds to an nth reference image.

The nth comparison image is an image captured at an image capture point Qn corresponding to the image capture point Pn. The second image described above corresponds to an nth comparison image.

The first region 410 displays the design drawing display field 301 at the lower left. The first region 410 includes the date field 306 indicating the image capture date and time of the nth reference image and a division end button 308 in the upper left. In a case where the division end button 308 is pressed, the display controller 112 returns the screen display of the display 23 from the comparison screen 400 to the display screen 300. The second region 420 displays the date field 306 indicating the image capture date and time of the nth comparison image in the left corner. The second region 420 displays, on the upper right, a viewpoint synchronization label 401 indicating that the nth reference image and the nth comparison image are synchronously displayed. By setting this control to be synchronous, the display controller 112 can simultaneously move the nth reference image and the nth comparison image in a synchronous manner, and by setting this control to be asynchronous, the nth reference image and the nth comparison image can be separately moved. By returning the setting from asynchronous to synchronous, the display controller 112 can also bring the nth reference image and the nth comparison image from a state of separately moving the nth reference image and the nth comparison image into a state of simultaneously moving the nth reference image and the nth comparison image in synchronous manner.

The first region 410 displays the walk-through instruction button 310 in the center.

When the selection instruction of the walk-through instruction button 310 is input by the user in the first region 410, the first region 410 switches the display of the nth reference image to an (n+1)th reference image.

At this time, the second region 420 switches the display of the nth comparison image to an (n+1)th comparison image.

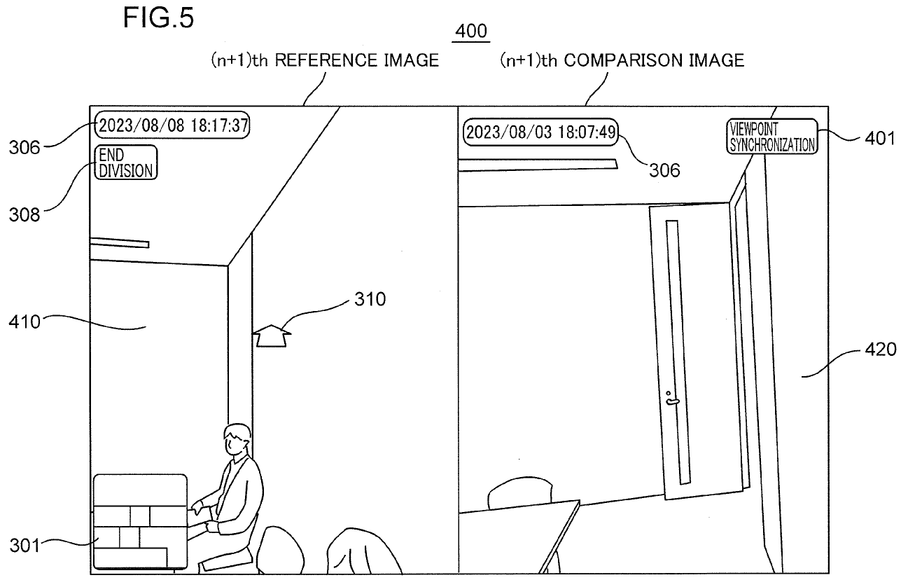

FIG. 5 is a diagram illustrating the comparison screen 400 to be displayed next to FIG. 4. As illustrated in FIG. 5, the first region 410 displays the (n+1)th reference image, and the second region 420 displays the (n+1)th comparison image. The (n+1)th reference image is an image captured at the image capture point Pn+1. The (n+1)th reference image corresponds to the third image described above. The (n+1)th comparison image is an image captured at an image capture point Qn+1 corresponding to the image capture point Pn+1. The (n+1)th comparison image corresponds to the fourth image described above.

Thereafter, every time the walk-through instruction button 310 is pressed, the reference image and the comparison image at the next image capture point are displayed on the display 23. As a result, the walk-through display is performed while maintaining a comparison state between the two images.

In this example, since the direction of the walk-through instruction button 310 faces the movement direction D1, in a case where the walk-through instruction button 310 is pressed, the (n+1)th reference image and the (n+1)th comparison image are displayed on the display 23. On the other hand, in a case where the walk-through instruction button 310 in a direction opposite to the movement direction D1 is pressed, an (n-1)th reference image and an (n-1)th comparison image are displayed on the display 23.

The nth reference image and the nth comparison image are omnidirectional images. Therefore, in a case where an operation of changing the image capture direction is input to one of the first region 410 or the second region 420 by the user by using the operation unit 24, the display controller 112 changes the image capture direction of the image displayed in the one region in accordance with the operation amount and the operation direction. At this time, the display controller 112 also changes the image capture direction of the image displayed in the other one of the first region 410 or the second region 420 in conjunction with the change of the image capture direction of the one image. This configuration further facilitates comparison between the two images.

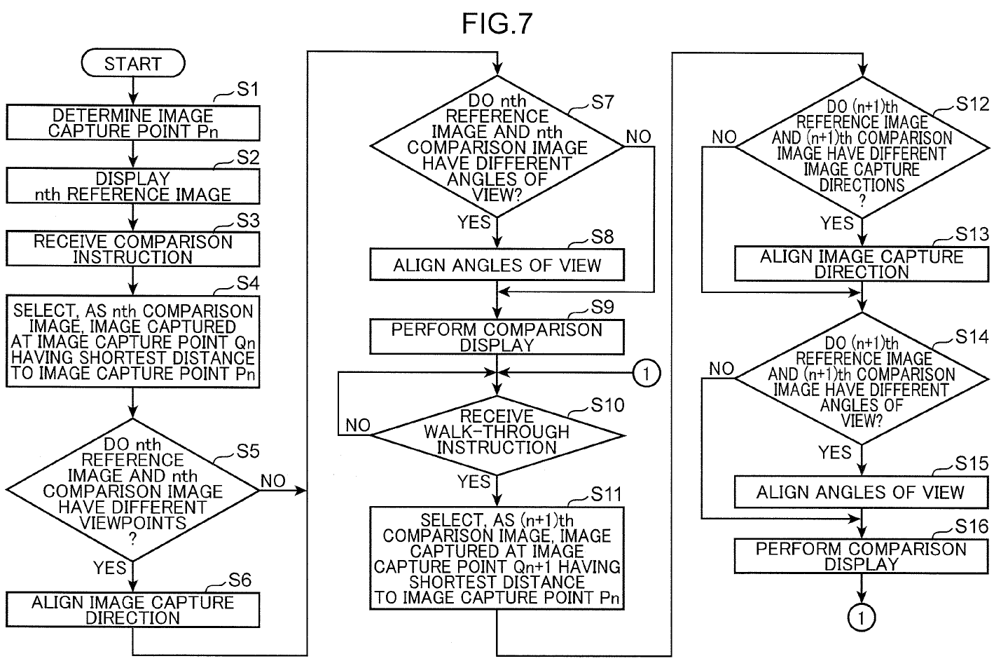

FIG. 7 is a flowchart illustrating processing of the information processing system 1 in the first embodiment. This flowchart starts when the image capture point icon 210n is selected on the design drawing screen 200 illustrated in FIG. 2.

In step S1, the display controller 112 determines the image capture point Pn on the basis of the instruction received by the instruction receiver 111. As illustrated in FIG. 2, when receiving an instruction to select the image capture point icon 210n, the information terminal 20 transmits the selection instruction to the server 10. The selection instruction includes an image capture ID. When the communication unit 13 receives this selection instruction, the instruction receiver 111 detects that the image capture point icon 210n is selected. The display controller 112 determines the image capture point Pn by using the image capture ID included in the selection instruction received by the instruction receiver 111 as a key.

Next, in step S2, the display controller 112 displays the nth reference image captured at the image capture point Pn determined in step S1. Specifically, the display controller 112 transmits display data of the nth reference image to the information terminal 20 by using the communication unit 13. In the information terminal 20, the processor 22 displays the display data received by the communication unit 21 on the display 23. As a result, the display screen 300 illustrated in FIG. 3A is displayed on the display 23.

Next, in step S3, the instruction receiver 111 receives a comparison instruction. The comparison instruction is input by pressing the comparison instruction button 307 displayed on the display screen 300. The processor 22 transmits the comparison instruction to the server 10 by using the communication unit 21. The comparison instruction transmitted from the information terminal 20 is received by the communication unit 13 and input to the instruction receiver 111. As a result, the instruction receiver 111 receives the comparison instruction.

Next, in step S4, the display controller 112 selects, as the nth comparison image, an image captured at the image capture point Qn having the shortest distance to the image capture point Pn. Specifically, the display controller 112 specifies, from the image information storage 124, a plurality of image capture points (a plurality of candidate image capture points) belonging to an image capture period (second image capture period) before the image capture period to which the image capture point Pn belongs. The display controller 112 specifies, as the image capture point Qn, a candidate image capture point having the shortest distance to the image capture point Pn of the plurality of specified candidate image capture points. For each of the plurality of candidate image capture points stored in the image information storage 124, the display controller 112 calculates a Euclidean distance to the image capture point Pn, and specifies, as the image capture point Qn, the candidate image capture point having the shortest Euclidean distance.

Next, in step S5, the display controller 112 determines whether the nth reference image and the nth comparison image have different image capture directions. In a case where it is determined that the image capture directions are different (YES in step S5), the processing proceeds to step S6, and in a case where it is determined that the image capture directions are not different (NO in step S5), the processing proceeds to step S7. The display controller 112 may determine YES in step S5 in a case where the image capture direction of the nth comparison image does not belong to a predetermined range of the image capture direction of the nth reference image.

Next, in step S6, the display controller 112 aligns the image capture direction of the nth comparison image with the image capture direction of the nth reference image.

Next, in step S7, the display controller 112 determines whether the nth reference image and the nth comparison image have different angles of view. In a case where it is determined that the angles of view are different (YES in step S7), the processing proceeds to step S8, and in a case where it is determined that the angles of view are not different (NO in step S7), the processing proceeds to step S9.

Next, in step S8, the display controller 112 aligns the angle of view of the nth comparison image with the angle of view of the nth reference image.

Next, in step S9, the display controller 112 compares and displays the nth reference image and the nth comparison image. Specifically, the display controller 112 transmits display data of the comparison screen 400 illustrated in FIG. 4 to the information terminal 20 by using the communication unit 13. As a result, the comparison screen 400 is displayed on the display 23.

Next, in step S10, the instruction receiver 111 determines whether a walk-through instruction has been received. In FIG. 4, when receiving the selection instruction of the walk-through instruction button 310, the information terminal 20 transmits the walk-through instruction to the server 10. In a case where the communication unit 13 receives the walk-through instruction, the instruction receiver 111 determines that the walk-through instruction has been accepted.

In a case where it is determined that the walk-through instruction has been received (YES in step S10), the processing proceeds to step S11, and in a case where it is determined that the walk-through instruction has not been received (NO in step S10), the processing stands by in step S10.

Next, in step S11, the display controller 112 selects, as the (n+1)th comparison image, an image captured at the image capture point Qn+1 having the shortest distance to the image capture point Pn+1. Specifically, the display controller 112 specifies, from the image information storage 124, a plurality of image capture points (a plurality of candidate image capture points) belonging to an image capture period (second image capture period) before the image capture period to which the image capture point Pn+1 belongs. The display controller 112 specifies, as the image capture point Qn+1, a candidate image capture point having the shortest distance to the image capture point Pn of the plurality of specified candidate image capture points.

Next, in step S12, the display controller 112 determines whether the (n+1)th reference image and the (n+1)th comparison image have different image capture directions. In a case where it is determined that the image capture directions are different (YES in step S12), the processing proceeds to step S13, and in a case where it is determined that the image capture directions are not different (NO in step S12), the processing proceeds to step S14. The display controller 112 may determine YES in step S12 in a case where the image capture direction of the (n+1)th comparison image does not belong to a predetermined range of the image capture direction of the (n+1)th reference image.

Next, in step S13, the display controller 112 aligns the image capture direction of the (n+1)th comparison image with the image capture direction of the (n+1)th comparison image.

Next, in step S14, the display controller 112 determines whether the (n+1)th reference image and the (n+1)th comparison image have different angles of view. In a case where it is determined that the angles of view are different (YES in step S14), the processing proceeds to step S15, and in a case where it is determined that the angles of view are not different (NO in step S14), the processing proceeds to step S16.

Next, in step S15, the display controller 112 aligns the angle of view of the (n+1)th comparison image with the angle of view of the (n+1)th reference image.

Next, in step S16, the display controller 112 compares and displays the (n+1)th reference image and the (n+1)th comparison image. Specifically, the display controller 112 displays the (n+1)th reference image in the first region 410 of the comparison screen 400 illustrated in FIG. 4 and displays the (n+1)th comparison image in the second region 420. As a result, the comparison screen 400 illustrated in FIG. 5 is displayed on the display 23. When the processing of step S16 ends, the processing returns to step S10.

As described above, in the first embodiment, upon detection of the walk-through instruction while the nth reference image and the nth comparison image are compared and displayed, the nth reference image is switched to the (n+1)th reference image, and the nth comparison image is switched to the (n+1)th comparison image. It is therefore possible to perform walk-through display of two images having different image capture dates and times. As a result, it is possible to display a plurality of images captured at another image capture point while maintaining the comparison display of the plurality of images without increasing processing steps.

### Modification of First Embodiment

FIG. 1B is an overall configuration diagram of an information processing system 1 according to a modification of the first embodiment. FIG. 1B is different from FIG. 1A in that the memory 12 further includes a BIM information storage 122 and an annotation information storage 125.

The BIM information storage 122 stores BIM information for each of a plurality of prescribed spaces. Each piece of BIM information is associated with a design drawing ID.

The annotation information storage 125 stores the annotation information. The annotation information is information including a comment and an annotation region attached to an image. The comment is a message in which a point or the like noticed by the user who has browsed the image displayed on the display 23 is written. The comment is input by using the operation unit 24. As a result, the user can call attention to other users.

The annotation region is a region set on the image by the user, and is a region indicating an annotation object related to the comment. The annotation region is set by using the operation unit 24. For example, if the prescribed space is a building site, the annotation object corresponds to a building member. For example, in a case where the user gives some kind of comment to a door, the annotation region is set by surrounding the door with a frame, and the comment is input in association with the annotation region. The image capture ID is associated with the annotation information. As a result, in which image the annotation information is set is specified.

FIG. 3B is a diagram illustrating an example of the display screen 300 displayed on the display in a case where the image capture point icon is selected in a modification of the first embodiment. The display screen 300 in FIG. 3B is different from the display screen 300 in FIG. 3A in that a picture button 302 and a BIM button 303 are further provided.

The BIM button 303 is a button for switching the display of the display screen 300 from the image Gn to the BIM image. The BIM image is an image obtained by rendering BIM information on the basis of the same direction as the image capture direction of the image Gn. The picture button 302 is a button for switching the BIM image to the image Gn.

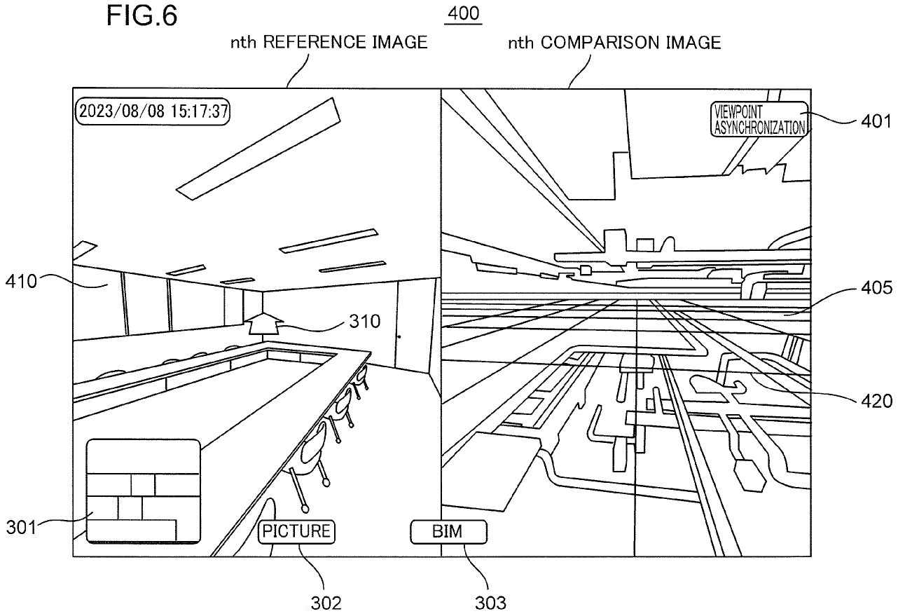

FIG. 6 is a diagram illustrating the comparison screen 400 in a case where the BIM image is displayed as the nth comparison image. For example, in a case where the instruction receiver 111 acquires an instruction for switching the display of the second region 420 to the BIM image from the information terminal 20, the display controller 112 displays, as the nth comparison image, the BIM image 405 viewed from the image capture point Pn instead of the image captured at the image capture point Qn. In a virtual three-dimensional space indicated by the BIM information, the display controller 112 sets a virtual camera as the image capture point Pn, sets the line of sight of the virtual camera in the same direction as the image capture direction of the nth comparison image, and renders the BIM information to generate the BIM image. In this case, the display controller 112 sets the angle of view of the BIM image 405 to the same angle of view as the angle of view of the nth comparison image displayed in the second region 420. As a result, the user can compare the BIM image 405 with the nth reference image.

Since the BIM image 405 indicates the state of a completed site, the user can confirm a progress status of the site by comparing the BIM image 405 with the nth reference image.

In a case where the walk-through instruction button 310 is pressed, the display controller 112 displays the image captured at the image capture point Pn+1 as the (n+1)th reference image in the first region 410. At the same time, the display controller 112 displays, as the (n+1)th comparison image, the BIM image 405 viewed from the image capture point Pn+1 in the second region 420. At this time, the display controller 112 sets the line of sight of the virtual camera of the BIM image 405 to the image capture direction of the (n+1)th reference image and sets the angle of view of the BIM image 405 to be the same as the angle of view of the (n+1)th reference image. As a result, the walk-through display is performed while the image captured at the image capture point and the BIM image are compared and displayed.

In the example of FIG. 6, the BIM image 405 is displayed in the second region 420, but this is an example, and a three-dimensional CAD image and a two-dimensional bird’s eye image (design drawing) of the prescribed space may be displayed instead of the BIM image 405. The second region 420 is only required to display a design drawing on which the image capture point icon 210 is superimposed. The second region 420 may display the design drawing such that the image capture point icon 210n is displayed near a center of the second region 420. Alternatively, the entire design drawing may be displayed in the second region 420 such that the image capture point icon 210n is displayed in a display mode different from the display mode of the other image capture point icons 210. As this display mode, for example, a mode can be adopted in which the image capture point icon 210n is blinked or displayed in a color different from the other image capture point icons.

### Second Embodiment

In a second embodiment, in a case where the first image and the second image are compared and displayed, if the annotation information is associated with the first image, the annotation information is also displayed on the second image, the third image, and the fourth image. In the present embodiment, the same constituent elements as those in the first embodiment are denoted by the same reference numerals, and description thereof will be omitted. The block diagram in FIG. 1B is used as a block diagram in the present embodiment.

See FIG. 1B. In a case where the annotation information is included in the first image, the display controller 112 determines whether the annotation object corresponding to the annotation information is included in the second image, the third image, and the fourth image. The display controller 112 displays the annotation information in the image determined to include the annotation object from among the second image, the third image, and the fourth image. The annotation object is an object annotated with the annotation information.

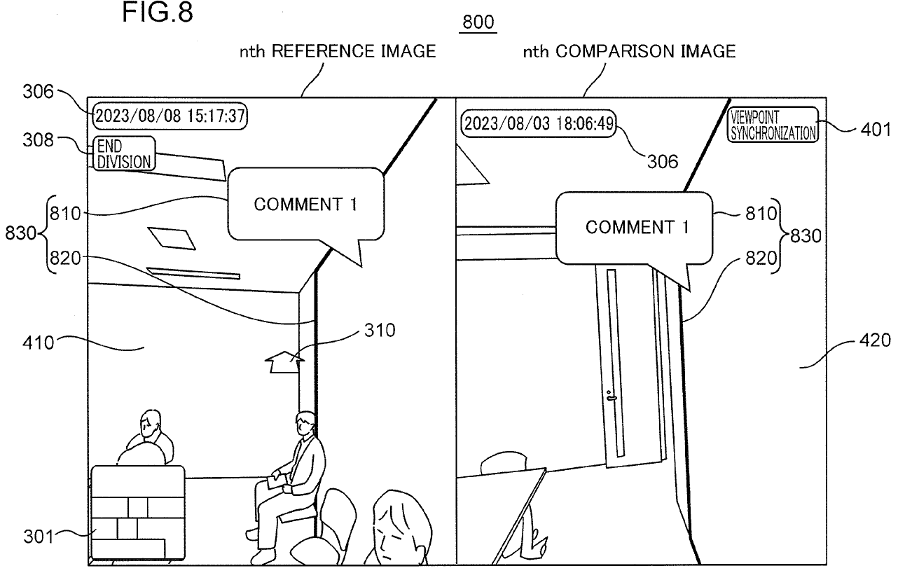

FIG. 8 is a diagram illustrating a comparison screen 800 on which annotation information 830 is displayed. The annotation information 830 is input by the user in advance on the display screen 300 illustrated in FIG. 3B, for example.

On the display screen 300, when an operation of pressing the edit button 304 is input by the user by using the operation unit 24, a comment input field (not illustrated) is displayed at a left end or a right end of the display screen 300. The user inputs an operation of designating the annotation object in the image Gn by a frame (not illustrated) by using the operation unit 24. The region designated by this frame is the annotation region 820. The user inputs a comment related to the annotation region 820 into the comment input field by using the operation unit 24. The information terminal 20 transmits, as the annotation information 830, information including the annotation region 820 and comment information 810 indicating the comment input by using the operation unit 24 to the server 10 by using the communication unit 21. The image capture ID is associated with the annotation information 830. The instruction receiver 111 of the server 10 stores the annotation information 830 received by the communication unit 13 in the annotation information storage 125 in association with the image capture ID of the image Gn. As a result, the annotation information 830 and the image Gn are associated with each other by using the image capture ID as a key.

In the example of FIG. 8, the annotation information 830 is associated with the nth reference image. In this example, a region surrounding a windowpane is set as the annotation region 820. The comment information 810 corresponding to the annotation region 820 is displayed in association with the annotation region 820.

In the example of FIG. 8, the nth comparison image is not associated with the annotation information 830. However, the nth comparison image includes the annotation object (windowpane) indicated by the annotation region 820 set in the nth reference image. Therefore, the annotation information 830 set in the nth reference image is also displayed in the nth comparison image.

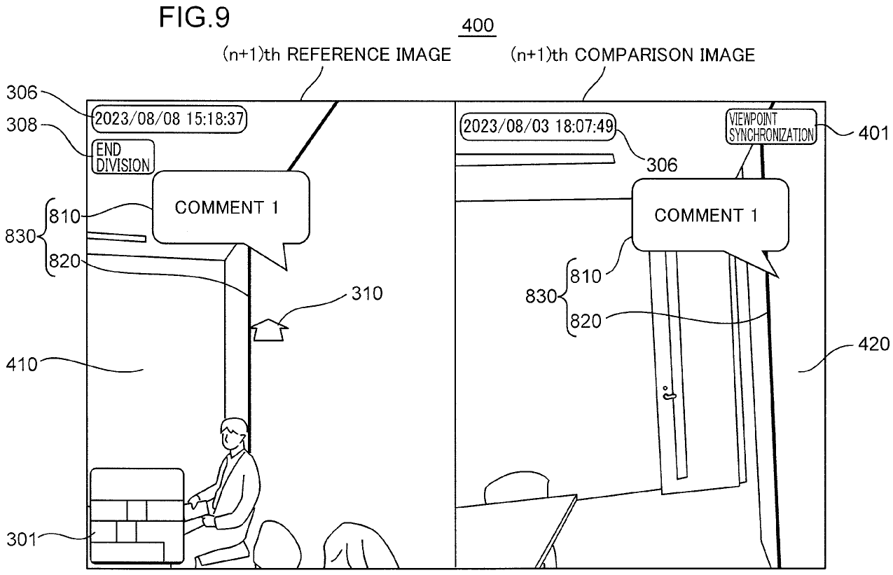

When an operation of pressing the walk-through instruction button 310 by the user is input in the first region 410 by using the operation unit 24, as illustrated in FIG. 9, the display of the first region 410 is switched to the (n+1)th reference image, and the display of the second region 420 is switched to the (n+1)th comparison image.

The (n+1)th reference image and the (n+1)th comparison image are not associated with the annotation information 830. However, the (n+1)th reference image and the (n+1)th comparison image each include the annotation object (windowpane) indicated by the annotation region 820 set in the nth reference image. Therefore, the annotation information 830 is also displayed in the (n+1)th reference image and the (n+1)th comparison image.

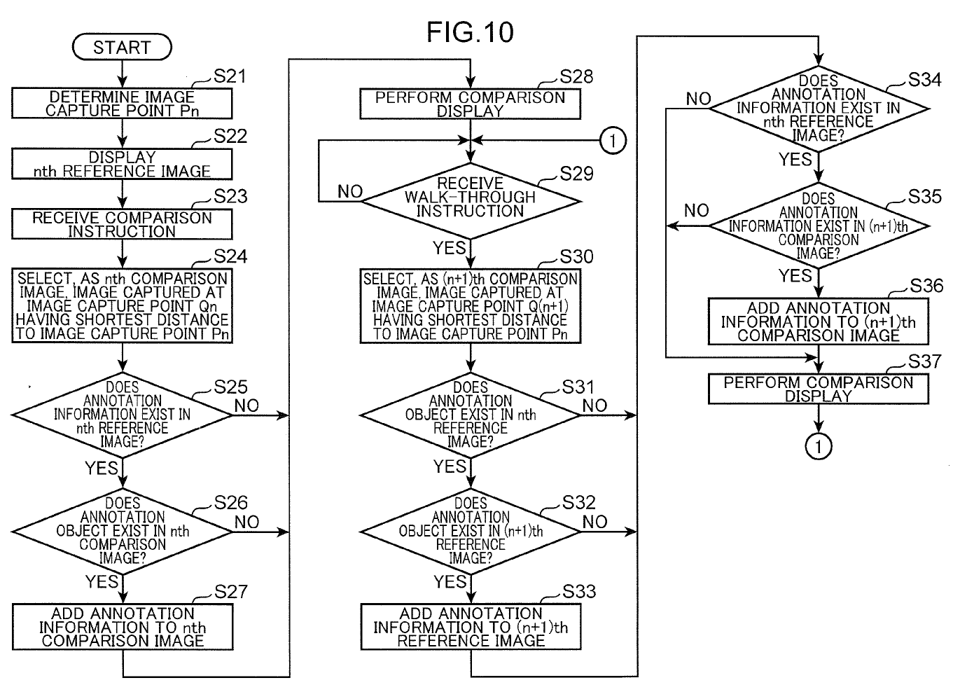

FIG. 10 is a flowchart illustrating processing of the information processing system 1 in the second embodiment. The processing in steps S21 to S24 is the same as the processing in steps S1 to S4 in FIG. 7.

In step S25, the display controller 112 determines whether the annotation information 830 exists in the nth reference image. When the annotation information associated with the image capture ID of the nth reference image exists among the annotation information stored in the annotation information storage 125, the display controller 112 is only required to determine that the annotation information exists in the nth reference image.

When the annotation information 830 exists in the nth reference image (YES in step S25), the processing proceeds to step S26, and when the annotation information 830 does not exist in the nth reference image (NO in step S25), the processing proceeds to step S28.

Next, in step S26, the display controller 112 determines whether the annotation object corresponding to the annotation information 830 of the nth reference image exists in the nth comparison image. For example, the display controller 112 is only required to determine whether the annotation object exists in the nth comparison image by applying template matching using the annotation region 820 included in the nth reference image as a template to the nth comparison image.

In a case where it is determined that the annotation object exists (YES in step S26), the processing proceeds to step S27, and in a case where it is determined that the annotation object does not exist (NO in step S26), the processing proceeds to step S28.

Next, in step S27, the display controller 112 adds the annotation information 830 to the nth comparison image. Specifically, the display controller 112 adds the frame to an outline of the annotation object included in the nth comparison image and adds the comment information 810 in association with the annotation object.

Next, in step S28, the display controller 112 displays the nth comparison image to which the annotation information 830 has been added (or has not been added) in the second region 420 to compare and display the nth reference image and the (n+1)th comparison image. As a result, the comparison screen 800 illustrated in FIG. 8 is displayed on the display 23.

The processing in steps S29 and S30 is the same as in steps S10 and S11 in FIG. 7, respectively.

Next, in step S31, the display controller 112 determines whether the annotation information 830 exists in the nth reference image. This processing is the same as in step S25. When the annotation information 830 exists in the nth reference image (YES in step S31), the processing proceeds to step S33, and when the annotation information 830 does not exist in the nth reference image (NO in step S31), the processing proceeds to step S34.

Next, in step S32, the display controller 112 determines whether the annotation object corresponding to the annotation information 830 of the nth reference image exists in the (n+1)th reference image. Details of this processing are the same as those in step S26.

In a case where it is determined that the annotation object exists (YES in step S32), the processing proceeds to step S33, and in a case where it is determined that the annotation object does not exist (NO in step S32), the processing proceeds to step S34.

Next, in step S33, the display controller 112 adds the annotation information 830 to the (n+1)th reference image. Details of this processing are the same as those in step S27.

Next, in step S34, the display controller 112 determines whether the annotation information 830 exists in the nth reference image. This processing is the same as in step S25.

When the annotation information 830 exists in the nth reference image (YES in step S34), the processing proceeds to step S35, and when the annotation information 830 does not exist in the nth reference image (NO in step S34), the processing proceeds to step S37.

Next, in step S35, the display controller 112 determines whether the annotation object corresponding to the annotation information 830 of the nth reference image exists in the (n+1)th comparison image. Details of this processing are the same as those in step S26.

In a case where it is determined that the annotation object exists (YES in step S35), the processing proceeds to step S36, and in a case where it is determined that the annotation object does not exist (NO in step S35), the processing proceeds to step S37.

Next, in step S36, the display controller 112 adds the annotation information 830 to the (n+1)th comparison image. Details of this processing are the same as those in step S27.

Next, in step S37, the display controller 112 displays the (n+1)th image to which the annotation information 830 has been added (or has not been added) in the first region 410, and displays the (n+1)th comparison image to which the annotation information 830 has been added (or has not been added) in the second region 420 to compare and display the (n+1)th reference image and the (n+1)th comparison image (step S37). As a result, the comparison screen 800 illustrated in FIG. 9 is displayed on the display 23. When the processing of step S37 ends, the processing returns to step S29.

In this manner, in the second embodiment, when the nth reference image includes the annotation information 830, it is determined whether the annotation object corresponding to the annotation information 830 exists in the nth comparison image, the (n+1)th reference image, and the (n+1)th comparison image. Then, when it is determined that the annotation object exists, the annotation information 830 is displayed in the (n+1)th reference image, the nth comparison image, and the (n+1)th comparison image determined that the annotation object exists. Therefore, it is easy to confirm the annotation information after the input of the walk-through instruction.

Note that the flowchart of FIG. 7 illustrates a case where the annotation information 830 exists in the nth reference image, but this is an example, and the annotation information 830 may exist in the nth comparison image. In this case, when the annotation object corresponding to the annotation information 830 in the nth comparison image is in any one of the nth reference image, the (n+1)th reference image, or the (n+1)th comparison image, the display controller 112 may display the annotation information 830 in the image.

In a case where the annotation information 830 does not exist in the nth reference image and the annotation information 830 exists in the nth comparison image, when the annotation object corresponding to the annotation information 830 in the nth comparison image is in the (n+1)th comparison image, the annotation information 830 may be displayed only in the (n+1)th comparison image.

In a case where the annotation information 830 does not exist in the nth comparison image and the annotation information 830 exists in the nth reference image, when the annotation object corresponding to the annotation information 830 in the nth reference image is in the (n+1)th reference image, the annotation information 830 may be displayed only in the (n+1)th reference image.

In a case where different annotation information 830a and 830b exist in each of the nth reference image and the nth comparison image, when an annotation object corresponding to the annotation information 830a exists in any of the nth comparison image, the (n+1)th reference image, or the (n+1)th comparison image, the display controller 112 may display the annotation information 830a in the image in which the annotation object exists. Furthermore, in this case, when the annotation object corresponding to the annotation information 830b exists in the nth reference image, the (n+1)th reference image, and the (n+1)th comparison image, the display controller 112 is only required to display the annotation information 830b in the image in which the annotation object exists.

### Third Embodiment

In a third embodiment, an image capture point at which a distance to the selection image capture point (image capture point Pn+1) is a designated distance or less and the distance is shortest is determined as the corresponding image capture point (image capture point Qn+1). In the present embodiment, the same constituent elements as those in the first and second embodiments are denoted by the same reference numerals, and description thereof will be omitted. The block diagram in FIGS. 1A or 1B is used as a block diagram in the present embodiment. As the designated distance, for example, a distance set in advance by the user is adopted.

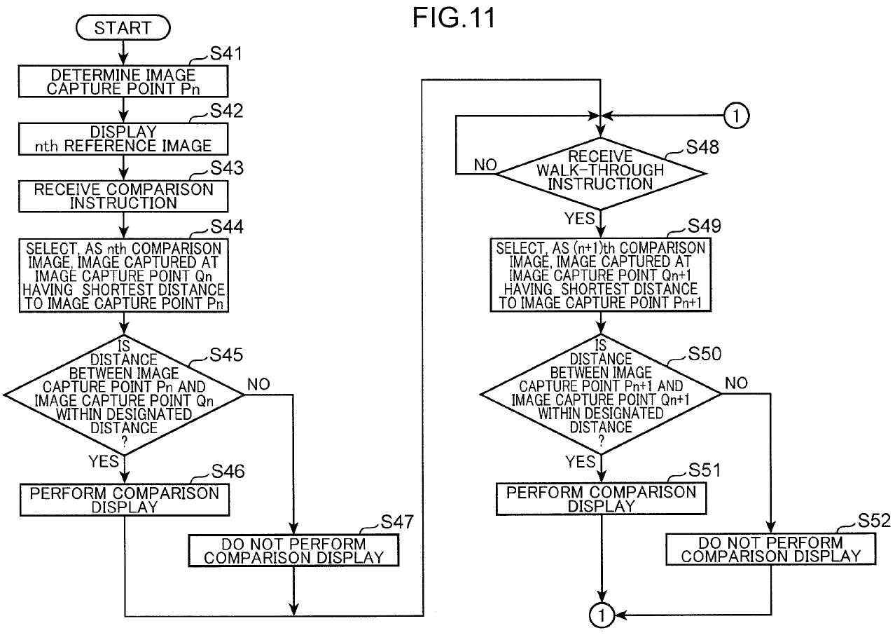

FIG. 11 is a flowchart illustrating processing of the information processing system 1 in the third embodiment. The processing in steps S41 to S44 is the same as in steps S1 to S4 in FIG. 7.

In step S45, the display controller 112 determines whether the distance between the image capture point Qn and the image capture point Pn is within the designated distance. In a case where the distance is within the designated distance (YES in step S45), the display controller 112 compares and displays the nth reference image and the nth comparison image (step S46). In this case, as illustrated in FIG. 4, the nth reference image is displayed in the first region 410, and the comparison screen 400 in which the nth comparison image is displayed in the second region 420 is displayed on the display 23.

On the other hand, in a case where the distance between the image capture point Qn and the image capture point Pn is not within the designated distance (NO in step S45), the display controller 112 does not compare and display the nth reference image and the nth comparison image (step S47). In this case, the nth reference image is displayed in the first region 410, and the comparison screen 400 in which nothing is displayed in the second region 420 is displayed on the display 23. As an aspect in which nothing is displayed, for example, an aspect can be adopted in which the second region 420 is displayed in a predetermined color (for example, black or gray). Furthermore, a message indicating that the image cannot be displayed may be displayed because the image captured at the image capture point within the designated distance to the image capture point Pn does not exist in the second region 420 displayed in the predetermined color.

The processing in steps S48 and S49 is the same as in steps S10 and S11 in FIG. 7.

Next, in step S50, the display controller 112 determines whether the distance between the image capture point Qn+1 and the image capture point Pn+1 is within the designated distance.

In a case where the distance between the image capture point Qn+1 and the image capture point Pn+1 is within the designated distance (YES in step S50), the display controller 112 compares and displays the (n+1)th reference image and the (n+1)th comparison image (step S51). In this case, as illustrated in FIG. 5, the (n+1)th reference image is displayed in the first region 410, and the comparison screen 400 in which the (n+1)th comparison image is displayed in the second region 420 is displayed on the display 23.

On the other hand, in a case where the distance between the image capture point Qn+1 and the image capture point Pn+1 is not within the designated distance (NO in step S50), the display controller 112 does not compare and display the (n+1)th reference image and the (n+1)th comparison image (step S52). In this case, the (n+1)th reference image is displayed in the first region 410, and the comparison screen 400 in which nothing is displayed in the second region 420 is displayed on the display 23.

In this manner, in the third embodiment, since two images having close image capture points are compared and displayed, it is easy to confirm a status change in a prescribed space.

### Fourth Embodiment

In a fourth embodiment, an image capture point whose image capture date and time are within a designated time from a selection image capture point (image capture point Pn+1) is determined as a corresponding image capture point (image capture point Qn+1). In the present embodiment, the same constituent elements as those in the first to third embodiments are denoted by the same reference numerals, and description thereof will be omitted. The block diagram in FIGS. 1A or 1B is used as a block diagram in the present embodiment. As the designated time, for example, a time set in advance by the user is adopted. As the designated time, for example, an appropriate value such as one month, one week, or one day can be adopted.

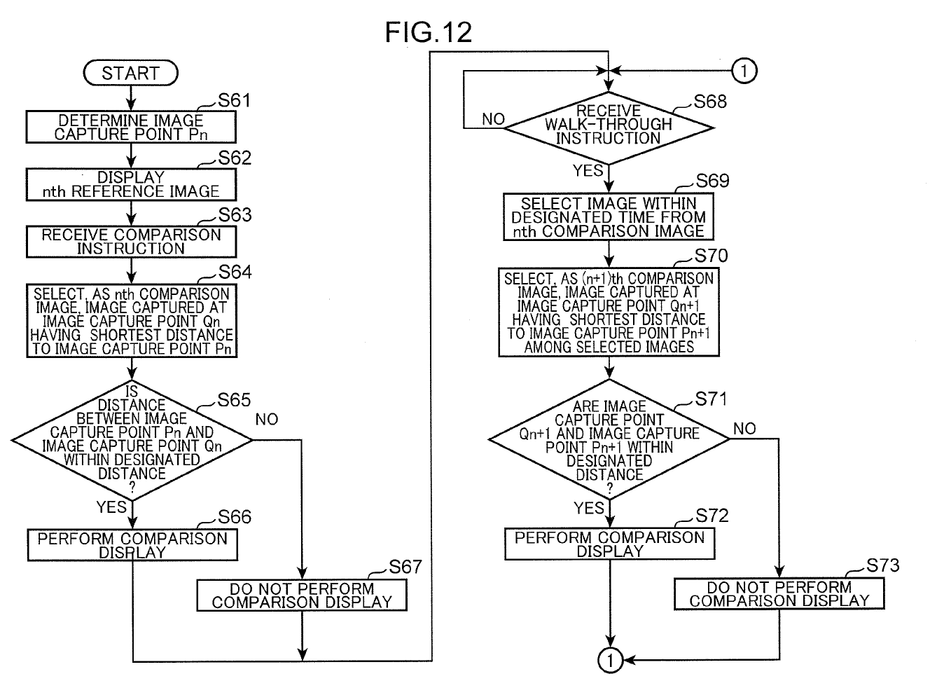

FIG. 12 is a flowchart illustrating processing of the information processing system 1 in the fourth embodiment. The processing in steps S61 to S68 is the same as in steps S41 to S48 in FIG. 11.

In step S69, the display controller 112 selects, from the image information storage 124, an image whose image capture date and time is within a designated time from the nth comparison image. Specifically, the display controller 112 selects, from the image information storage 124, an image captured within a designated time from the image capture date and time of the nth comparison image among the plurality of image capture points belonging to the image capture period (second image capture period) before the image capture period to which the image capture point Pn belongs.

Next, in step S70, the display controller 112 determines, as the (n+1)th comparison image, an image captured at the image capture point Qn+1 having the shortest distance to the image capture point Pn+1 among the selected images.

Next, in step S71, the display controller 112 determines whether the distance between the image capture point Qn+1 and the image capture point Pn+1 is within the designated distance. In a case where the distance is within the designated distance (YES in step S71), the processing proceeds to step S72, and in a case where the distance is not within the designated distance (NO in step S71), the processing proceeds to step S73.

The processing of steps S72 and S73 is the same as in steps S51 and S52 illustrated in FIG. 11. When the processing of steps S72 and S73 ends, the processing returns to step S68.

In this manner, in the fourth embodiment, since the two images whose image capture date and time are within the designated time are compared and displayed, it is easy to confirm the status change in the prescribed space within the designated time.

### Fifth Embodiment

In a fifth embodiment, in a case where two images are images captured in the same subspace in a prescribed space, the comparison display is performed. The subspace refers to a space divided by a column or a wall, and corresponds to a room, a booth, a corridor, an elevator hall, an entrance hall, or the like. The subspace refers to a space in which the view is not obstructed by a pillar or the like during construction.

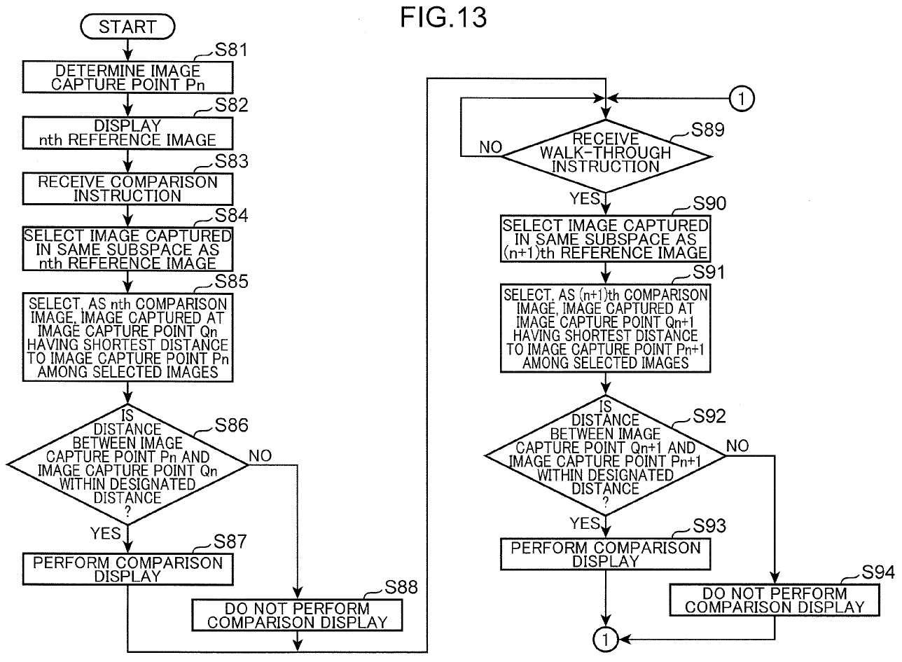

FIG. 13 is a flowchart illustrating processing of the information processing system 1 in the fifth embodiment. The processing in steps S81 to S83 is the same as in steps S1 to S3 in FIG. 7.

In step S84, the display controller 112 selects an image captured in the same subspace as the nth reference image from the image information storage 124. For example, the display controller 112 is only required to specify a region corresponding to the subspace to which the image capture point Pn belongs in the design drawing of the prescribed space, extract an image in which the image capture point belongs in the region corresponding to the specified subspace from the image information storage 124, and select the extracted image as an image captured in the same subspace. In a case where the prescribed space is a building site, the region of the subspace changes in accordance with the progress status of the construction. Therefore, in the design drawing of the prescribed space, a mode may be adopted in which the contour line indicating the subspace is updated in accordance with the progress status of the construction. In this case, the display controller 112 may determine whether images have been captured in the same subspace by using the latest design drawing. Alternatively, a plurality of design drawings corresponding to the progress status of the construction from the start to the end of the construction may be created in advance. In this case, the display controller 112 may select a design drawing closest to the current time point from among the plurality of design drawings created in advance and determine whether an image has been captured in the same subspace by using the selected design drawing.

Next, in step S85, the display controller 112 selects, as the nth comparison image, an image captured at the image capture point Qn having the shortest distance to the image capture point Pn among the images selected in step S84.

The processing in step S86 to S89 is the same as in steps S65 to S68 in FIG. 12.

Next, in step S90, the display controller 112 selects an image captured in the same subspace as the (n+1)th reference image from the image information storage 124. Details of this processing are the same as those in step S84.

Next, the processing in steps S91 to S94 is the same as in steps S70 to S73 in FIG. 12.

In this manner, the display controller 112 determines whether the image capture point of the nth reference image (first image) and the image capture point of the nth comparison image (second image) are located in the same subspace and displays the nth comparison image (second image) upon determination that the image capture points are located in the same subspace. Furthermore, the display controller 112 determines whether the image capture point of the (n+1)th reference image (third image) and the image capture point of the (n+1)th comparison image (fourth image) are located in the same subspace and displays the (n+1)th comparison image (fourth image) upon determination that the image capture points are located in the same subspace. Therefore, it is easy to compare two images captured in the same subspace. In a case where the subspace is not defined, there is a possibility that a point of a locus of a subspace different from the prescribed space is associated, instead of a space in the same room as the prescribed space or in the same corridor. In this case, the field of view is blocked by the pillar or the wall, the desired site cannot be compared, and as a result, there is a possibility that the comparison target becomes an error. By defining the subspace, the occurrence of the error is suppressed.

Modifications described below can be adopted for the present disclosure.

(1) In the above embodiment, the walk-through instruction is input by the walk-through instruction button 310, but the present disclosure is not limited thereto, and the walk-through instruction may be input by inputting an operation of selecting an image capture point icon displayed in the design drawing display field 301 indicated on the comparison screen 400. In this case, the display controller 112 may scroll the design drawing displayed in the design drawing display field 301 such that the selected image capture point icon 210 is located near the center of the screen.

(2) In a case where the operation of changing the angle of view in one of the first region 410 or the second region 420 is input, the display controller 112 may change the angle of view of the image displayed in the other one of the first region 410 or the second region 420 in conjunction with the change of the angle of view in the one region.

Furthermore, in this case, the display controller 112 may enlarge or reduce the design drawing displayed in the design drawing display field 301 in conjunction with the change in the angle of view.

(3) The annotation information 830 includes the comment information 810 and the annotation region 820 but may include one of the comment information or the annotation region.

(4) In FIGS. 4 and 5, the walk-through instruction button 310 is provided in the first region 410 but may be provided in the second region 420. In this case, in a case where the walk-through instruction button 310 in the second region 420 is pressed, the image displayed in the second region 420 may be treated as the reference image, and the image displayed in the first region 410 may be treated as the comparison image.

The present disclosure is useful in the technical field of managing the progress status of construction at a building site from a remote place.

1. An information processing method in a computer, the method comprising:
displaying, on a display of an information terminal, a first image that is obtained by capturing a prescribed space on a first date and time;
displaying, on the display, a second image that is obtained by capturing the prescribed space on a second date and time that is different from the first date and time, and
upon detection of a selection of a selection image capture point that is different from an image capture point on the first date and time or the second date and time
while the first image and the second image are being displayed,
switching display of the first image to display of a third image that is obtained at the selection image capture point; and
switching the display of the second image to display of a fourth image that is captured at a corresponding image capture point that corresponds to the selection image capture point.

2. The information processing method according to claim 1, wherein each of the first image, the second image, the third image, and the fourth image is configured by an omnidirectional image.

3. The information processing method according to claim 1, wherein one of an image group including the first image and the third image or an image group including the second image and the fourth image is configured by an omnidirectional image, and another one of the image groups is configured by a three-dimensional simulation image of the prescribed space or a two-dimensional bird’s eye image of the prescribed space.

4. The information processing method according to claim 1, further comprising:
displaying the first image and the second image on the display such that image capture directions coincide with each other; and
displaying the third image and the fourth image on the display such that image capture directions of the third image and the fourth image coincide with each other.

5. The information processing method according to claim 1, further comprising:
displaying the first image and the second image on the display such that angles of view coincide with each other; and
displaying the third image and the fourth image on the display such that angles of view of the third image and the fourth image coincide with each other.

6. The information processing method according to claim 1, further comprising in a case where one of the first image or the second image includes annotation information, determining whether an annotation object corresponding to the annotation information is included in another one of the first image or the second image and at least one of the third image or the fourth image, and displaying the annotation information in an image determined to include the annotation object among the another image, the third image, and the fourth image.

7. The information processing method according to claim 1, wherein the corresponding image capture point is an image capture point at which a distance to the selection image capture point is shortest among image capture points at which the distance to the selection image capture point is a designated distance or less.

8. The information processing method according to claim 1, wherein the corresponding image capture point is an image capture point whose image capture date and time is within a designated time from the selection image capture point.

9. The information processing method according to claim 1, wherein
the prescribed space includes a plurality of subspaces, and
the method further includes
determining whether an image capture point of the first image and an image capture point of the second image are located in a same subspace, and displaying the second image upon determination that the image capture points are located in the same subspace; and
determining whether an image capture point of the third image and an image capture point of the fourth image are located in a same subspace, and displaying the fourth image upon determination that the image capture points are located in the same subspace.

10. The information processing method according to claim 1, wherein
the third image is an image captured on a date and time one date and time before or one date and time after the first date and time, and
the fourth image is an image captured on a date and time one date and time before or one date and time after the second date and time, or is an image captured at an image capture point close to an image captured on a date and time one date and time before or one date and time after the first date and time, and is an image captured at an image capture time close to a date and time one date and time before or one date and time after the second date and time.

11. The information processing method according to claim 1, wherein the second image is an image captured at an image capture point corresponding to the image capture point of the first image.

12. An information processing device comprising a processor that executes:
displaying, on a display of an information terminal, of a first image that is obtained by capturing a prescribed space on a first date and time;
displaying, on the display, of a second image that is obtained by capturing the prescribed space on a second date and time that is different from the first date and time, and
upon detection of a selection of a selection image capture point that is different from an image capture point on the first date and time or the second date and time
while the first image and the second image are being displayed,
switching of display of the first image to display of a third image that is obtained at the selection image capture point; and
switching of the display of the second image to display of a fourth image that is captured at a corresponding image capture point that corresponds to the selection image capture point.

13. A non-transitory computer readable recording medium storing an information processing program that causes a computer to:
display, on a display of an information terminal, a first image that is obtained by capturing a prescribed space on a first date and time;
display, on the display, a second image that is obtained by capturing the prescribed space on a second date and time that is different from the first date and time, and
upon detection of a selection of a selection image capture point that is different from an image capture point on the first date and time or the second date and time
while the first image and the second image are being displayed,
switch display of the first image to display of a third image that is obtained at the selection image capture point; and
switch the display of the second image to display of a fourth image that is captured at a corresponding image capture point that corresponds to the selection image capture point.
